(19) United States
(12) Patent Application Publication
(10) Pub. No.: US 2012/0072158 A1
(43) Pub. Date: Mar. 22, 2012

(54) TEST METHOD AND SYSTEM FOR TESTING IMAGE PROCESSOR OF ELECTRONIC DEVICE

(75) Inventor: JUN-JIE LI, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 12/978,524

(22) Filed: Dec. 24, 2010

(30) Foreign Application Priority Data
Sep. 21, 2010 (CN) 201010288797.1

(51) Int. Cl. G06F 19/00

(52) U.S. Cl. 702/108

(57) ABSTRACT

A test system for testing an image processor of an electronic device by controlling the image processor to playback a test image divided into several pixel areas is provided, therein, each pixel area includes several rows of pixels, and pixel values of the rows of pixels of one pixel area are respectively the same. The test system includes a storage device, a test module, and a test device. The storage device stores a pixel value of one row of each pixel area, and position of the pixel areas of the test image (test data). When the electronic device connects to the storage device, the test module invokes the test data from the storage device, recovers the test image according to the test data, and controls the image processor to produce a corresponding image signal. The test device judges performance of the image processor according to the image signal.

### BACKGROUND

1. Technical Field

The present disclosure relates to test methods, particularly to a method for testing an image processor of an electronic device.

2. Description of Related Art

Image processors to be used in electronic devices need to be tested. One test method is to control the image processor of the electronic device to playback a standard image, and then determine performance of the image processor by analyzing signals output by it. Usually, a standard image is stored in a flash memory, such as a secure digital (SD) card, and the electronic device connects to the flash memory and obtains the standard image from it during testing. However, the standard image is relatively large and thus requires a large capacity flash memory, which is costly.

Therefore, it is desirable to provide a system and a method to overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a test system for testing the quality of an image processor of an electronic device, in accordance with an exemplary embodiment.

FIG. 2 is a schematic view showing a test image divided into pixel areas, in accordance with an exemplary embodiment.

FIG. 3 is a method for testing the quality of an image processor of an electronic device applied in a test system, such as, for example, that of FIG. 1, in accordance with an exemplary embodiment.

### DETAILED DESCRIPTION

Embodiments of the present disclosure will now be described in detail below, with reference to the accompanying drawings.

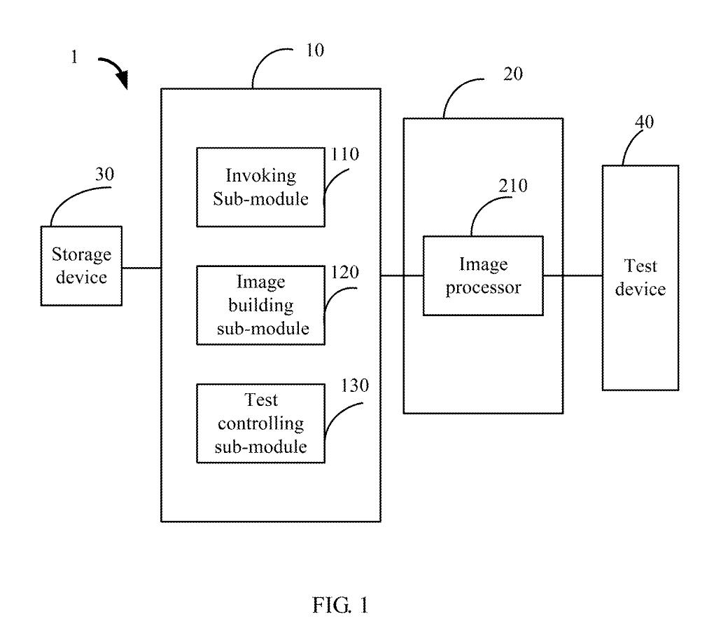

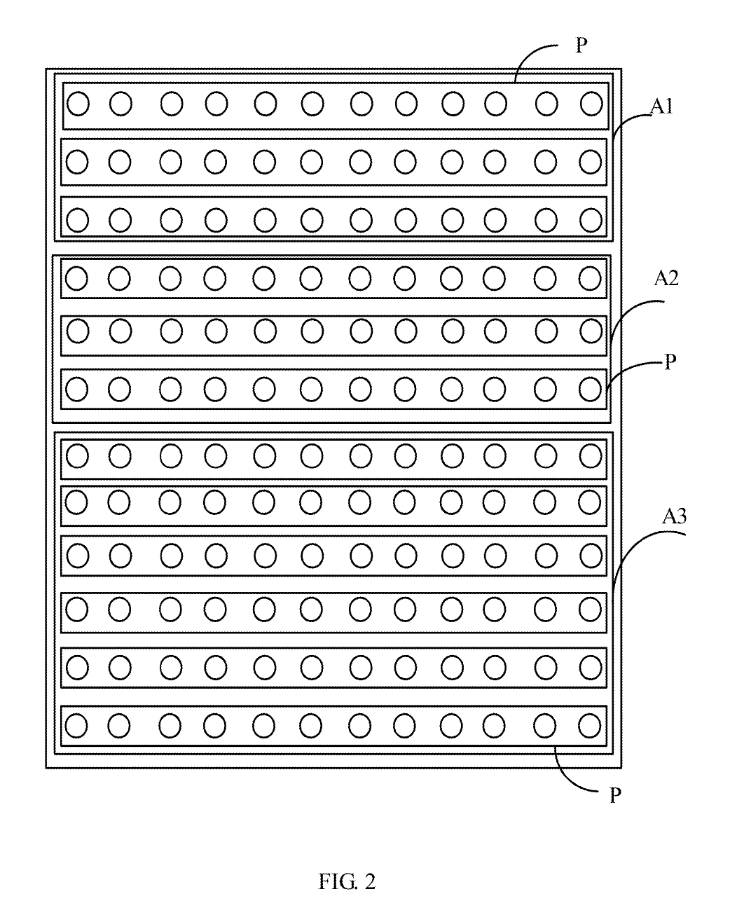

Referring to FIGS. 1 and 2, a test system 1 including a test module 10, an electronic device 20, a storage device 30, and a test device 40, is provided. The test system 1 is configured for testing an image processor 210 of the electronic device 20. The storage device 30 stores a portion of data of a test image derived from portions of the image data after the image data has been divided into a number of pixel areas (see FIG. 2). The storage device 30 can be, for example, a hard disk, a floppy disk, or a flash memory.

In the embodiment, each pixel area of the test image includes a number of rows of pixels and pixel values of the pixels of each row of the pixel area are respectively the same. For example, as shown in FIG. 2, the test image includes a first, a second, and a third pixel area A1, A2, A3. The first pixel area A1 includes three rows of pixels from the first row to the third row, and the pixel values of pixels of the first, the second, and the third row are respectively the same, namely the pixel value of the pixel in row 1 column 1 is the same as that of the pixel in row 2 column 1, and that of the pixel in row 3 column 1; the pixel value of the pixel in row 1 column 2 is the same as that of the pixel in row 2 column 2, and that of the pixel in row 3 column 2, and so on. The second pixel area A2 includes three rows of pixels from the fourth row to the sixth row, and the pixel value of pixels of the fourth to the sixth row are respectively the same. The third pixel area A3 includes six rows of pixels from the seventh row to the twelfth row, and the pixel value of pixels of the seventh row to the twelfth row are respectively the same.

Furthermore, in the embodiment, each row of the pixel areas A1, A2, and A3 is defined as a pixel sub-group P. Because the pixel values of pixels of each row of one pixel area are respectively the same, the storage device 30 only stores the pixel values of the pixels of one of the pixel sub-groups P of the first pixel area A1, the second pixel area A2, and the third pixel area A3, and the position of the first pixel area A1, the second pixel area A2, and the third pixel area A3 (hereinafter, the test data). In the embodiment, location of each pixel of the image is identified by coordinates of a coordinate system, such as a Cartesian coordinate system, the position of each pixel area can be expressed by two sets of coordinates, one set of coordinates for the first pixel and last pixel in the first pixel sub-group P of the pixel area, and one set of coordinates for the first and last pixel in the last pixel sub-group P of the pixel area. For example, the position of the first pixel area A1 is expressed as {(1, 1), (1, 12), (3, 1), (3, 12)}.

Therefore, in the embodiment, because the storage device 30 does not need to store all pixel values of the test image, but only the pixel values of the pixels of one of the pixel sub-groups P of each pixel area and the position of each pixel area, the size of the image data is much less than that of the whole test image.

The test module 10 includes an invoking sub-module 110, an image building sub-module 120, and a test controlling sub-module 130. The test module 10 can be stored in the electronic device 20 or the storage device 30. In the embodiment, the test module 10 is an auto-run program, and can be run automatically when the electronic device 20 connects to the storage device 30.

When the electronic device 20 connects to the storage device 30, the invoking sub-module 110 invokes the test data from the storage device 30. The image building sub-module 120 respectively builds the first, the second, and the third pixel areas A1, A2, and A3 at the corresponding positions according to the test data. For example, the image building sub-module 120 respectively builds the pixel areas to the corresponding positions by copying the pixel values of pixels of one sub-group P and applying them to the corresponding respective positions of the pixels of the other sub-groups in the corresponding pixel area, and so on until all pixel areas are built and the test image is formed.

The test controlling sub-module 130 controls the image processor 210 to output an image signal corresponding to the test image to the test device 40. The test device 40 receives the image signal output by the image processor 210 and determines performance of the image processor 210 according to the image signal.

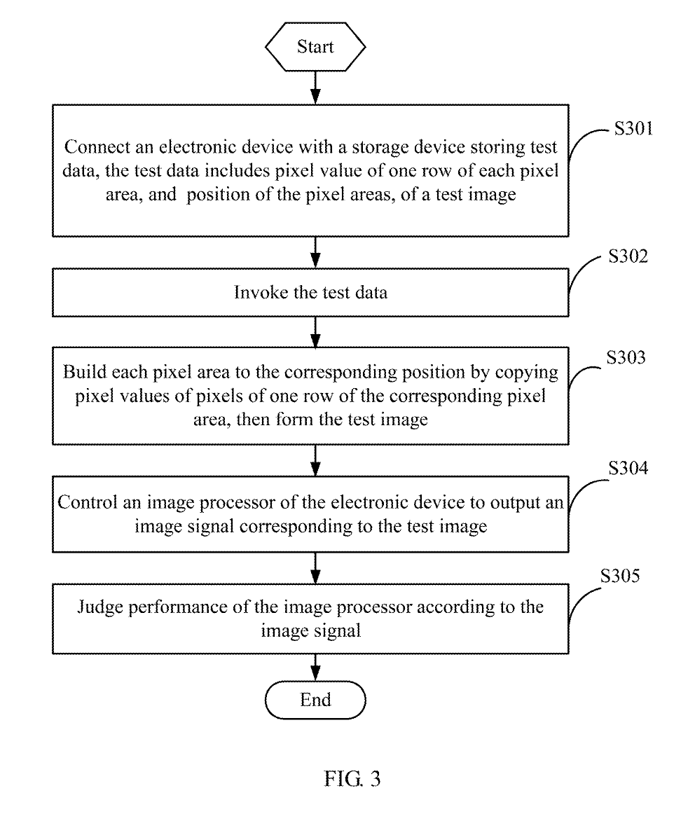

FIG. 3 is a flowchart illustrating a method for testing the image processor 210 of the electronic device 20. In step S301, the electronic device 20 connects to the storage device 30 storing pixel value of one pixel sub-group of each pixel area of a test image, and position of the pixel areas (test data).

In step S302, the invoking sub-module 110 invokes the test data of the test image.

In step S303, the image building sub-module 120 respectively builds the pixel areas at the corresponding positions according to the test data. Namely, the image building sub-module 120 respectively builds the pixel areas to the corresponding positions by copying the pixel values of pixels of one sub-group P and applying them to the corresponding respective positions of the pixels of the other sub-groups in the corresponding pixel area, and so on until all pixel areas are built the test image is formed.

In step S304, the test controlling sub-module 130 controls the image processor 210 to output an image signal corresponding to the test image.

In step S305, the test device 40 judges performance of the image processor 210 according to the image signal.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A test system for testing an image processor of an electronic device by controlling the image processor to playback a test image divided into several pixel areas, each pixel area comprising several rows of pixels, and pixel values of the rows of pixels of one pixel area being respectively the same, the test system comprising:
a storage device storing test data by recording pixel value of one row of each of pixel areas, and positions of the pixel areas, of the test image;
a test module comprising:
an invoking sub-module, configured to invoke the test data from the storage device when the electronic device connects to the storage device;
an image building sub-module, configured to form the test image by respectively building the each pixel areas at the corresponding positions according to the test data; and
a test controlling sub-module, configured to control the image processor to produce an image signal corresponding to the test image; and
a test device, configured to receive the image signal outputted by the image processor and judge the quality of the image processor according to the image signal.

2. The test system according to claim 1, wherein the image building sub-module respectively builds the each pixel area at the corresponding positions according to the test data is: copies the pixel values of pixels of one row and applies them to the corresponding respective positions of the pixels of the other rows in the corresponding pixel area, and so on until all pixel areas are built the test image is formed.

3. The test system according to claim 1, wherein the test module is an auto-run program and is stored in the electronic device, and is run automatically when the electronic device connects to the storage device.

4. The test system according to claim 1, wherein the test system is an auto-run program and is stored in the storage device, and is run automatically when the electronic device connects to the storage device.

5. The test system according to claim 1, wherein the position of each pixel area are expressed by two sets of coordinates, one set of coordinates for the first pixel and last pixel in the first row of the pixel area, and one set of coordinates for the first and last pixel in the last row of the pixel area.

6. The test system according to claim 1, wherein the storage device is selected from the group consisting of a hard disk, a floppy disk, and a flash memory.

7. A method for testing an image processor of an electronic device, comprising:
connecting the electronic device with a storage device storing test data of a test image, the test data comprising pixel value of one row of each pixel area, and position of the pixel areas, of the test image;
invoking the test data;
forming the test image by building each pixel area respectively at the corresponding positions according to the test data;
controlling the image processor to output an image signal corresponding to the test image; and
judging performance of the image processor according to the image signal.

8. The method according to claim 7, wherein the step “forming the test image by building each pixel area respectively at the corresponding positions according to the test data” comprises:
copying the pixel values of pixels of one row; and
applying them to the corresponding respective positions of the pixels of the other rows in the corresponding pixel area, and so on until all pixel areas are built the test image is formed.
